(19) United States
(12) Patent Application Publication
(10) Pub. No.: US 2016/0107438 A1
(43) Pub. Date: Apr. 21, 2016

(54) PRINTER OPERATION FOR EJECTION OF PURGING DROPLETS OF A PRINTING FLUID

(71) Applicants: Antonio GRACIA VERDUGO, Barcelona (ES); Oriol BORRELL AVILA, Barcelona (ES); Ana Cristina GARCIA ALVAREZ, Barcelona (ES); HEWLETT-PACKARD DEVELOPMENT COMPANY, L.P., Houst, TX (US)

(72) Inventors: Antonio Gracia Verdugo, Barcelona (ES); Oriol Borrell Avila, Sabadell (ES); Ana Cristina Garcia Alvarez, Sant Cugat del Valles (ES)

(21) Appl. No.: 14/787,465

(22) PCT Filed: Jul. 26, 2013
(86) PCT No.: PCT/EP2013/065798

§ 371 Date: Oct. 27, 2015

(51) Int. Cl. B41J 2/045

(52) U.S. Cl. CPC B41J 2/04535; B41J 2/04586

(57) ABSTRACT

Operation of a printer for printing an image is described herein. It is determined whether ejection of imaging droplets of a print fluid via a set of nozzles for printing an outstanding image portion is sufficient for preventing clogging of the set of nozzles. Upon determining that ejection of imaging droplets for printing the outstanding image portion is sufficient for preventing clogging of the set of nozzles, printing is performed by ejecting only imaging droplets of the print fluid via the set of nozzles. Upon determining that ejection of imaging droplets for printing the outstanding image portion is not sufficient for preventing clogging of the set of nozzles, a servicing procedure is to be executed of to eject purging droplets of the print fluid via the set of nozzles.

### BACKGROUND

Some printing systems, commonly referred to as inkjet printers, form a printed image by ejecting print fluids from printheads. Print fluids may include inks and or other print fluids (e.g., a pre-treatment or a post-treatment print fluid that facilitate improving quality or durability of a printed pattern). Thereby, a print fluid is applied onto a print medium for printing a pattern of individual dots at particular locations. The printed pattern reproduces an image on the printing medium.

Generally, print fluids include a solid component, for example ink pigments or treatment compositions. Drying of print fluids might cause that clogs are formed at nozzles in the printheads. Clogs might be also formed by minute dust particles or paper fibers reaching the nozzles.

During operation of inkjet printers, clogs in printheads may be periodically cleared by firing a number of drops of a print fluid through nozzles in the printhead in a process known as “spitting.”

### BRIEF DESCRIPTION OF THE DRAWINGS

In order that the present disclosure may be well understood, various examples will now be described with reference to the following drawings.

FIG. 1 is a block diagram schematically illustrating a printing system in which examples can be implemented.

FIG. 2 is a block diagram schematically illustrating a portion of the printing system of FIG. 1.

FIG. 3 is a block diagram schematically illustrating components for implementing examples.

FIGS. 4 and 5 are block diagrams illustrating printer operation according to examples herein.

FIG. 6 is a block diagram illustrating how a print density counting function can be evaluated according to examples herein.

FIG. 7 is a block diagram illustrating printer operation according to examples herein.

FIG. 8 is an illustration of an image printed according to examples herein.

### DETAILED DESCRIPTION

In the following description, numerous details are set forth to provide an understanding of the examples disclosed herein. However, it will be understood that the examples may be practiced without these details. While a limited number of examples have been disclosed, it should be understood that there are numerous modifications and variations therefrom. Similar or equal elements in the Figures may be indicated using the same numeral.

Clogs in a printhead may be periodically cleared by spitting. For example, spitting may be performed by ejecting waste print fluid in a reservoir portion in a service station of the printer (often referred to as “spitton”).

Alternatively, or in addition thereto, spitting may be performed by purging print fluid droplets over the print media. This process is hereinafter referred to as “flying spit”. Flying spit may be implemented as follows: selected nozzles of a printhead may be fired to deposit image print fluid droplets on a print media page to print an image. In a purging step, selected nozzles are purged by firing to deposit purging print fluid droplets on the page. Purging print fluid dots are scattered randomly over the page or in background areas for preventing compromising print quality. Flying spit may include purging inks of different colors as well as transparent print fluids (e.g. pre/post treatment fluids).

Generally, during flying spit a selected number of drops is ejected after a selected number of passes. In other words, N₁ purging drops may be ejected every N₂ passes for implementing flying spit, N₁ being a number of purging drops and N₂ a number of passes. For example, between 30 to 125 drops may be purged per every single pass.

In at least some printing systems, spitting is performed without considering how a nozzle or a set of nozzles is being operated during a print swath. In other words, in some printing systems, spitting may be performed independently of the ink density to be printed by a specific set of nozzles. However, spitting without consideration of nozzle operation may not be efficient. For example, if a specific set of nozzles has been used for printing before nozzles are purged then such servicing is, in principle, unnecessary since the printing itself can clear formed clogs in the nozzles and the purging results in an unnecessary ejection of print fluids. Further, if a specific set of nozzles is not to be operated during the print passes between which purging is performed, then purging also results in an unnecessary ejection of print fluids since, for these passes, nozzle clogging is irrelevant.

It has been proposed to enhance efficiency of the purging process by (i) determining the last time that a servicing operation is performed in a printhead, and (ii) performing a servicing operation in response to the last time the printhead was refreshed exceeding a predetermined value. However, this approach does not take into account whether the printhead is going to be operated in the next swath for printing, which, as set forth above, might render a previous servicing unnecessary and hence results in unnecessary ejection of print fluids. It has also been proposed to monitor and count the number of times each nozzle is fired for each pass of a print carriage over a print zone. Thereby, this monitoring may be done on a predictive basis, by analyzing image data before the image droplets are fired. Thereby, image and purging droplets can be ejected during the same pass if desired. However, such an approach may be computationally inefficient.

In contrast to the previous proposals above for preventing nozzle clogging, examples herein facilitate enhanced and variable spitting by taking into account ejection of a print fluid (e.g., inks and/or treatment fluids) during printing of an outstanding image portion. As illustration, in at least some of the examples disclosed herein, it is determined whether ejection of imaging droplets of a print fluid via a set of nozzles for printing an outstanding image portion is sufficient for preventing clogging of the set of nozzles. Depending on the determination, different print routines are followed: upon determining that ejection of imaging droplets for printing the image portion is sufficient for preventing clogging of the set of nozzles, the outstanding image portion is printed by ejecting only imaging droplets of the print fluid via the set of nozzles; upon determining that ejection of imaging droplets for printing the outstanding image portion is not sufficient for preventing clogging of the set of nozzles, a servicing procedure is executed to eject purging droplets of the print fluid during printing the area corresponding to the outstanding image portion via the set of nozzles. The purging droplets may be ejected in a servicing station or over the printing area (i.e., by flying spitting). In at least some of these examples, the outstanding image portion corresponds to one or more subsequent print swaths.

As used herein, a print swath refers to the area printable by a printhead while being operated to print across a print media. For example, in a single-pass printer, a print swath refers to what is printed in a single pass of a printhead over the media. In a multiple-pass printer, a print swath refers to what is printed in multiple passes of a printhead over the media before the media is advanced to print a subsequent pass. In a non-scanning, page-wide printer (e.g., HP Inkjet Web Press), a print swath refers to the area printable over the print media by a single operation of the non-scanning printhead.

As used herein, imaging droplets of a printing fluid refers to droplets ejected to reproduce a digital image on the substrate. Imaging droplets are ejected on a printing dot corresponding to a pixel of the digital image for reproduction thereof. Imaging droplets may be comprised of a print fluid for color reproduction (e.g., a colored ink) or other types of print fluids such as a treatment fluid for improving print quality or durability of the printed pattern. Purging droplets of a printing fluid refers to droplets ejected for preventing nozzle clogging. Droplets may be ejected on a service station or on the print media by flying spit. In flying spit, purging droplets are typically ejected to prevent substantially impacting quality of the printed image.

The following description is broken into sections. The first, labeled “Environment,” describes environments in which examples may be implemented. The second section, labeled

“Components,” describes various physical and logical components for implementing various examples. The third section, labeled as “Operation,” describes steps taken to implement various embodiments.

### Environment

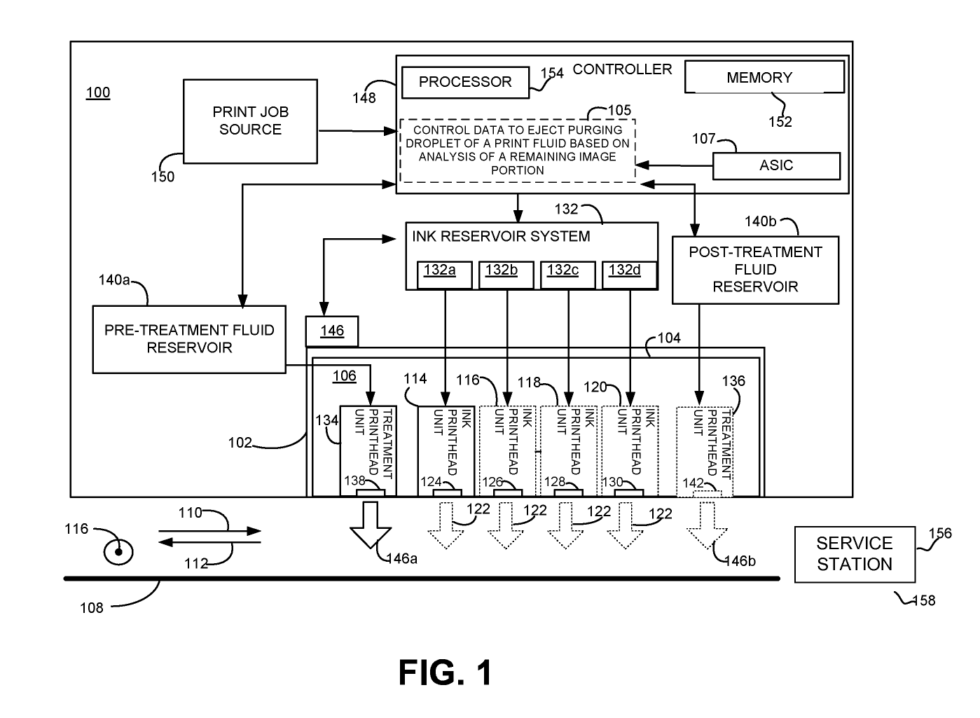

FIG. 1 is a block diagram of a printer 100, in which examples can be implemented. It will be understood that the following description of printer 100 is merely illustrative and does not limit the components and functionality of examples described in the present disclosure.

As shown in the diagram, printer 100 includes a carriage 102 with a printhead receiving assembly 104. In the illustrated example, printer 100 is illustrated including printhead 106 in printhead receiving assembly 104. Carriage 102 is to transition printhead 106 across the width of a print media 108, i.e., along printhead transition directions 110, 112. For example a drive 146 may be coupled to carriage 102 for effecting carriage transition. Thereby, printer 100 can perform printing across a width of print media 108 via translation of carriage 102. In other examples, printhead 106 is a page-wide array printhead and translation is not required for printing across a width of print media 108.

Printhead 106 in this example is illustrated to include a plurality of ink printhead units 114, 116, 118, 120. Each of the ink printhead units is configured to eject ink 122 of a different color via respective ink nozzle array arrangement 124, 126, 128, 130 Ink printhead units 114, 116, 118, 120 are fluidly connected to an ink reservoir system 132. Ink reservoir system 132 includes ink reservoirs 132a, 132b, 132c, 132d for providing ink to the respective ink printhead units. In the illustrated example, ink reservoirs 132a, 132b, 132c, 132d respectively store cyan ink, magenta ink, yellow ink, and black ink.

Base colors may be reproduced on print media 108 by depositing a drop of one of the above mentioned inks onto a print media location. Further, secondary colors can be reproduced by combining ink from different ink printhead units. In particular, secondary or shaded colors can be reproduced by depositing drops of different base colors on adjacent dot locations in the print media location (the human eye interprets the color mixing as the secondary color or shading). It will be understood that further ink reservoirs may be provided. For example, a CcMmKY system may include further ink reservoirs for light cyan (c) and light magenta (m).

According to some examples herein, printer 100 may include at least one printhead unit for ejecting a pre-treatment fluid 146a and/or at least one printhead unit for ejecting a post-treatment fluid 146b. In the example of FIG. 1, treatment printhead units 134, 136 are for treating a print media location (e.g., any of print media dot locations 504 depicted in FIG. 5B). Treatment printhead unit 134 is for applying a pre-treatment 146a (e.g., a fixer) on the print media location via a pre-treatment nozzle set 138. More specifically, in at least some examples herein, a treatment fluid to be deposited is a fixer. A fixer fluid may be configured as described in U.S. Pat. Nos. 4,694,302, 5,746,818, or 6,132,021, which are incorporated by reference.

Treatment printhead unit 134 is for applying a post-treatment 146b (e.g., a coating) on the print media location via a post-treatment nozzle set 142. A post-treatment may be as described by US patent application with application Ser. No. 12/383066 published under publication number US 2012/0120142.

The block diagram in FIG. 1 shows treatment printhead units 134, 136 fluidly connected to, respectively, a pre-treatment fluid reservoir 140a and a post-treatment fluid reservoir 140b. Treatment fluid reservoirs 140a, 140b are to store the treatment fluid to be jetted by treatment nozzles 138, 142. For example, pre-treatment fluid reservoir 140a may store a printing fluid including an ink fixer component; post-treatment fluid reservoir 140b may store a printing fluid including a coating component.

Ink reservoir system 132 and treatment fluid reservoirs 140a, 140b may include disposable cartridges (not shown). The reservoirs may be mounted on carriage 102 in a position adjacent to the respective printhead. In other configurations (also referred to as off-axis systems), the reservoirs are not mounted on carriage 102 and a small fluid supply (ink or treatment) is externally provided to the printhead units in carriage 102; main supplies for ink and fixer are then stored in the respective reservoirs. In an off-axis system, flexible conduits are used to convey the fluid from the off-axis main supplies to the corresponding printhead cartridge. Printheads and reservoirs may be combined into single units, which are commonly referred to as “pens”.

It will be appreciated that examples can be realized with any number of printhead units depending on the design of the particular printing system, each printhead unit including a nozzle array for jetting a printing fluid such as ink or treatment. For example, printer 100 may include at least one treatment printhead unit, such as two or more treatment printhead units. Furthermore, printer 100 may include at least one ink printhead unit, such as two to six ink printhead units, or even more ink printhead units.

In the illustrated examples, ink printhead units are located at one side of a treatment printhead. It will be understood that ink printheads may be located at both sides of a treatment printhead. Further, printhead units might be monolithically integrated in printhead 106. Alternatively, each printhead unit might be modularly implemented in printhead 106 so that each printhead unit can be individually replaced. Further, printhead 106 may be a disposable printer element or a fixed printer element designed to last for the whole operating life of printer 100.

Printer 100 further includes a service station 156 at an area 158 in the proximity of print media 108. Purging droplets (not shown) of any of the print fluids ejectable via printer 100 can be deposited into service station 156 for servicing the nozzles in the printheads described above. Thereby, carriage 102 may translate to position the printhead to be serviced over the service station. Purging might also be performed by flying spit over print media 108.

Printer 100 further includes a controller 148, which is operatively connected to the above described elements of printer 100. Controller 148 is shown configured to execute a print job received from a printjob source 150.

Further, controller 148 is to execute the print job according to control data 105 to eject purging droplets of a print fluid (e.g., any of inks 122 or treatment fluid 146a, 146b) based on an analysis of an outstanding image portion to be printed. For example, controller 148 may be initiated to control printing of an image portion over an outstanding print swath for reproducing a portion of the print job. For each print swath, control data 105 may be generated by controller 148, or a separated computing unit, by (i) determining for the outstanding image portion (e.g., an outstanding print swath) whether imaging droplets of a print fluid to be ejected via the nozzles in any of the printhead units for printing of the image portion are sufficient for preventing clogging of the nozzle set, and (ii) if it is determined that no imaging droplets of the print fluid are to be ejected for printing such an outstanding image portion, then control data 105 may determine ejection of purging droplets of the print fluid during printing of the current image portion if the set of nozzles requires servicing. (A nozzle set may correspond to the whole nozzle set for ejecting a specific print fluid or a sub-set thereof.) Control data 105 may implement other examples of purging droplets ejection disclosed herein.

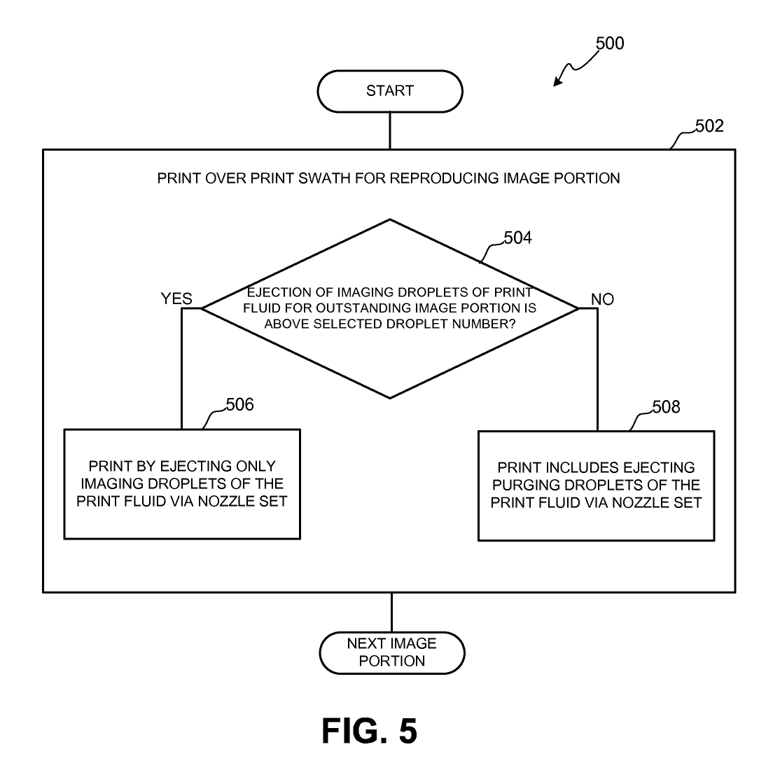

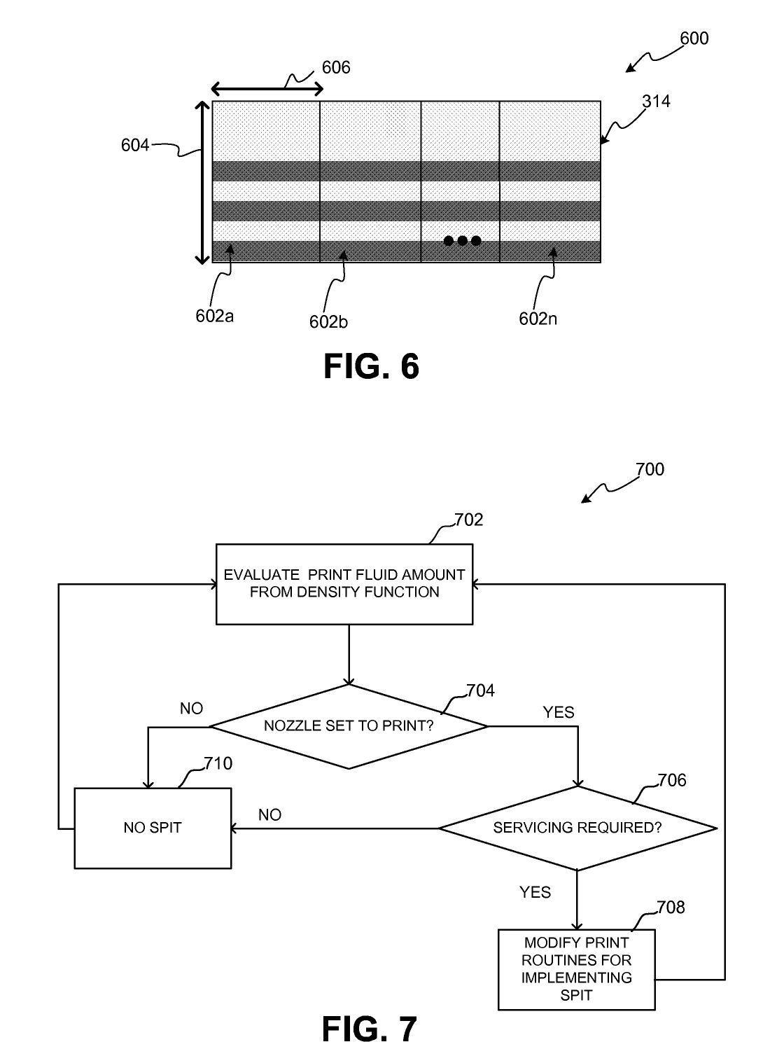

In some examples herein, controller 148 may include a specific engine for generating control data 105. In the illustrated example, controller 148 includes an application-specific integrated circuit (ASIC) engine 107. In some examples, such a count engine is customized for providing a print fluid density counting function. Such a print fluid density counting function is further illustrated below with respect to FIGS. 6 AND 7.

Controller 148 is shown to include processor 154. Processor 154 is configured to execute methods as described herein. Processor 154 may be implemented, for example, by one or more discrete processing units (or data processing components) that are not limited to any particular hardware, firmware, or software (i.e., machine readable instructions) configuration. Processor 154 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other versions, the respective functionalities of each of one or more of the modules are performed by a respective set of multiple data processing components.

Memory device 152 is accessible by controller 148 and, more specifically, by processor 154. Memory device 152 may be integrated within controller 148 or may be a separate component communicatively connected to controller 148. Memory device 152 stores process instructions (e.g., machine-readable code, such as computer software) for implementing methods executed by controller 148 and, more specifically, by processor 154.

Program instructions in memory device 152 may be part of an installation package that can be executed by processor 154 to implement control engine 108. In this case, memory 152 may be a portable medium such as a CD, DVD, or flash drive or a memory maintained by a server from which the installation package can be downloaded and installed. In another example, the program instructions may be part of an application or applications already installed. Here, memory 152 can include integrated memory such as a hard drive. It should be noted that a tangible medium as used herein is considered not to consist of a propagating signal and rather being of non-transitory nature, e.g., at least for the operating lifetime of the medium.

Controller 148 receives printjob commands and data from printjob source 150, which may be a computer or any other source of printjobs, in order to print an image based on a print mask. The received data may include control data 105. A print mask refers to logic that includes control data determining which nozzles of the different printheads are fired at a given time to eject fluid in order to reproduce a printjob. The print mask may be processed according to control data 105 by processor 154 in order to cause ejection of print fluids according to examples herein. In an example, control data 105 forms part of a print mask supplied by print job source 150. Alternatively, control data 105 might be implemented in the print mask by a pre-processing performed by processor 154, or any other processor, so that purging droplets are ejected as disclosed herein.

Controller 148 is operatively connected to treatment printhead units 134, 136, ink printhead units 114, 116, 118, 120, and the respective reservoirs to control, according to the print mask and the control data in memory 152. Thereby, controller 148, and more specifically processor 154, can control functionality of printer 100 such as, but not limited to performing nozzle servicing according to control data 105.

It will be understood that the functionality of memory 152 and print job source 150 might be combined in a single element or distributed in multiple elements. Further, controller 148, or elements thereof, may be provided as external elements of print system 100. Further, it will be understood that operation of processor 154 to control treatment ejection is not limited to the above examples.

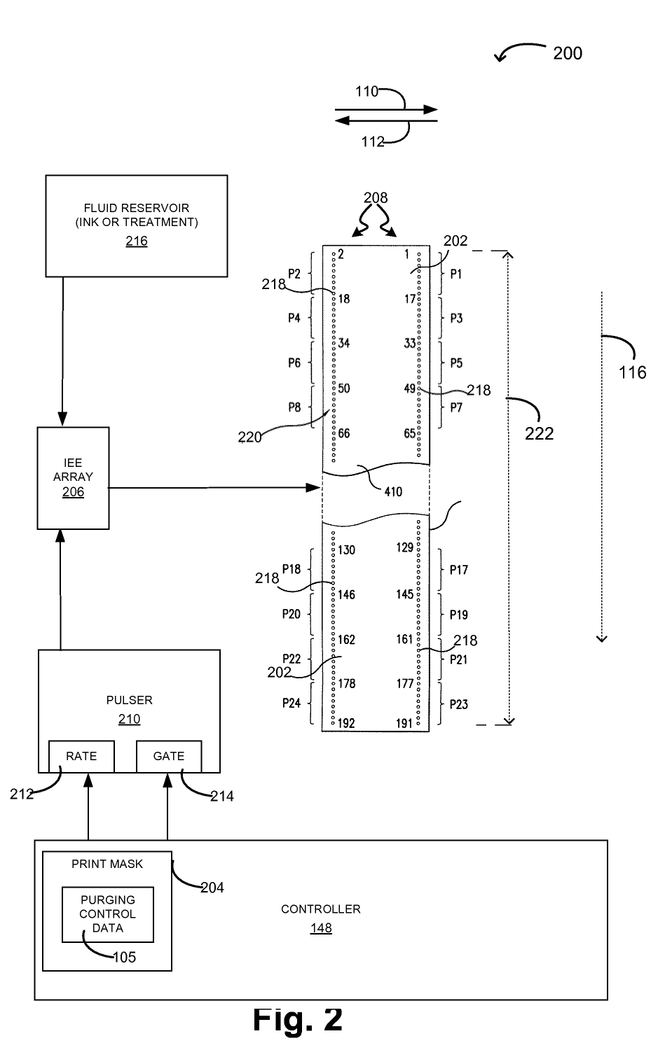

FIG. 2 is a block diagram of a portion 200 of printing system 100 illustrating an example of printhead firing control. The example is illustrated for a printhead 202, which may correspond to a treatment printhead (e.g., corresponding to any of treatment printheads units 134, 136) or to an ink printhead (e.g., any of ink printheads 114, 116, 118, 120). Controller 148 may provide a print mask 204 to a pulser 210. Print mask 204 is built according to purging control data 105. Pulser 210 may be located on or off printhead 202 depending on the particular printing system. Pulser 210 may process data from print mask 204 to generate pulses that controls an ink ejection element (IEE) array 206 associated to nozzle array 208. IEE array 206 includes IEEs (not shown) operatively coupled to a nozzle or a group of nozzles in nozzle array 208. In the illustrated example, controller 148 provides firing data to pulser 210 on two lines: i) a rate line 212 for setting the pulse rate; and ii) a gate line 214 for setting which pulses are to be forwarded to a particular IEE. Electrodes (not shown) on carriage 102 (see FIG. 1) may forward the pulses.

The particular fluid ejection mechanism within the printhead may take on a variety of different forms such as those using piezo-electric or thermal printhead technology. For example, if the fluid ejection mechanism is based on a thermal printhead technology, the pulses forwarded to an IEE of IEE array 206 may be forwarded as a current pulse that is applied to a resistor within the particular IEE. The current pulse causes a fluid droplet (not shown), formed with fluid (i.e., ink or treatment fluid) from a fluid reservoir 216 (e.g., ink reservoir 132a-132d or treatment fluid reservoir 140a, 140b), to be ejected from the nozzle associated with the particular IEE.

FIG. 2 further illustrates a particular arrangement of a printhead 202. The depicted elements of printhead 202 are not to scale and are exaggerated for simplification. Printhead 202 includes nozzle array 208 formed by individual nozzles 218. Nozzles 218 may be of any size, number, and pattern. A fluid ejection chamber (not shown) may be located behind nozzles 218 and contains IEEs associated to nozzles 218. A specific group of nozzles (hereinafter referred to as a primitive 220) may be allocated for being fired simultaneously. Nozzle array 208 may be arranged into any number of multiple subsections with each subsection having a particular number of primitives operated by a particular number of IEEs. In the illustrated example, printhead 202 has 192 nozzles with 192 associated firing IEEs; the 192 nozzles (nozzles 1 to 192) are allocated in 24 primitives (primitives P1 to P24) arranged in two columns of 12 primitives each.

The length of the rows of nozzles along the media advance direction defines a print swath 222. In this example, the width of this band along media advance direction 116 defines the “swath width,” i.e. the maximum pattern of print fluid which can be laid down in a single transition of carriage 102. As set forth above, a print swath may also refer to what is printed in multiple passes of a printhead over the media before the media is advanced to print a subsequent pass, or, in a non-scanning, page-wide printer, to the area printable over the print media by a single operation of the non-scanning printhead.

### Components

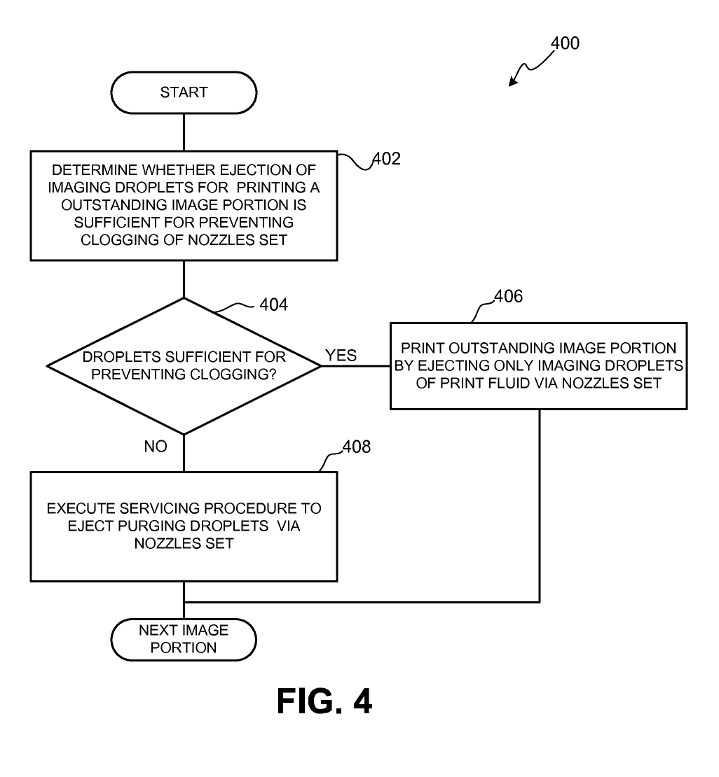

At least some of the functionality described herein can be implemented as components comprised of a combination of hardware and programming configured for performing tasks described herein (for example, blocks in the flow charts illustrated below with respect to FIGS. 4, 5 and 6).

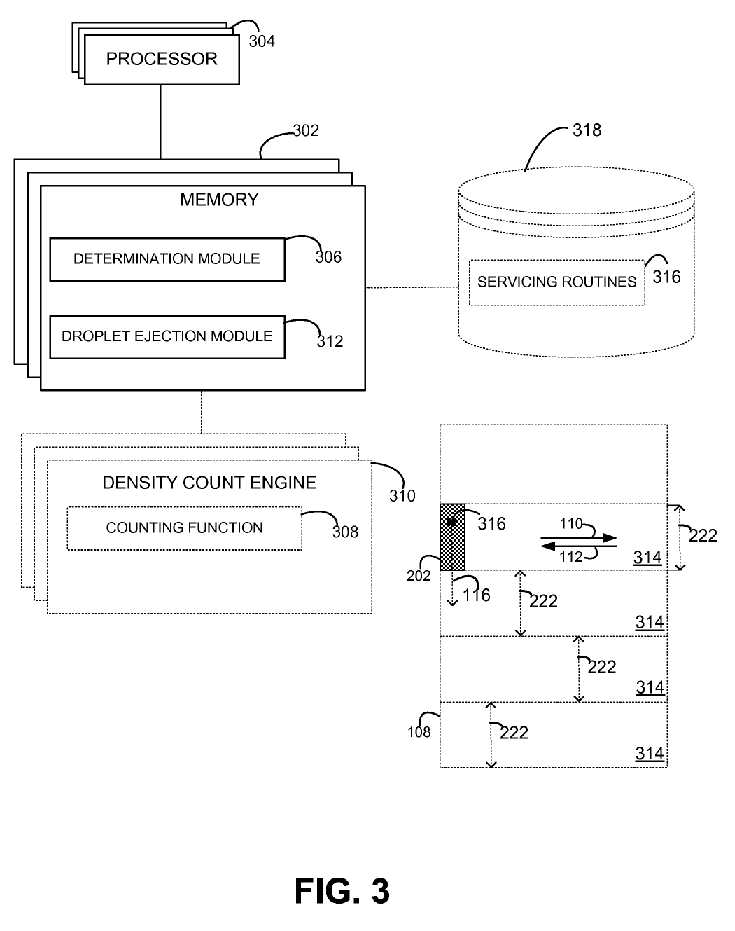

FIG. 3 depicts examples of physical and logical components for implementing at least some of the examples illustrated herein. In illustrating FIG. 3, reference is made to printer 100 in FIG. 1 and the components in FIG. 2. It will be understood that this reference is merely illustrative and does not limit components of examples herein.

In the example of FIG. 3, the programming may be processor executable instructions stored on a tangible memory media 302, e.g., memory 152 depicted in FIG. 1, and the hardware may include processor 304, which might be implemented by processor 154 depicted in FIG. 1, for executing those instructions. Memory 302 can be said to store program instructions that when executed by processor 304 implements, at least partially, controller 148 shown in FIG. 1. Memory 302 may be integrated in the same device as processor 304, e.g. such as illustrated in FIG. 1 with memory 152 and processor 154 forming part of controller 148, or it may be separate but accessible to that device and processor 304. Memory 302 and processor 304 may be respectively comprised of single, integrated components or may be distributed over a number of discrete memory units and processor units. Such discrete memory units and processor units may be included in the same integrated component (e.g., controller 148) or may be distributed over different, communicatively connected, components (e.g., a controller comprised of multiple discrete components).

Program instructions in memory 302 may be part of an installation package that can be executed by processor 304 to implement examples herein. In this case, memory 304 may be a portable medium such as a CD, DVD, or flash drive or a memory maintained by a server from which the installation package can be downloaded and installed. In another example, the program instructions may be part of an application or applications already installed. Here, memory 302 can include integrated memory such as a hard drive. It should be noted that a tangible medium as used herein is considered not to consist of a propagating signal. In examples, the medium is a non-transitory medium.

In FIG. 3 the executable program instructions stored in memory 302 are depicted as a determination module 306 and a droplet ejection module 312. It will be understood that these modules may be combined or configured differently as shown in FIG. 3 for realizing examples disclosed herein.

Determination module 306 is configured to determine whether ejection of imaging droplets of a print fluid via a set of nozzles for printing an outstanding image portion 314 is sufficient for preventing clogging of a set of nozzles (e.g., nozzles 218 of printhead 202 depicted in FIG. 2). As illustrated in FIG. 3, outstanding image portion 314 may be an image portion corresponding to one or more print swaths 222 to be printed subsequently, i.e., downstream of an actual position 316 of printhead 202 over print media 108.

For performing the determination, module 306 may access a counting function 308 provided by a density count engine 310. Density counting function 308 is configured to provide an estimate of the amount of print fluid to be printed in the outstanding image portion (e.g., one or more subsequent print swaths) via the set of nozzles for which the determination is being performed (e.g., nozzles in a printhead for a specific print fluid). In such examples, determination module 306 performs the determination based on, at least, the estimate of the amount of print fluid to be printed such as further illustrated below with respect to FIGS. 6 and 7.

Density count engine 310 may be provided as part of an ASIC and density counting function 308 may be implemented as a programmed function in the ASIC. It will be understood that there is a variety of alternatives for implementing density count engine 310 and density counting function 308. For example, density counting function 308 may be implemented as a programmed routine in a digital signal processor (DSP).

Droplet ejection module 312 is configured to control ejection of purging droplets according to the determination performed by determination module 306. For example, droplet ejection module 312 may cause nozzles in printhead 202 to eject purging droplets of a print fluid over the image portion to be currently printed or a service station upon determination module 306 determining that ejection of imaging droplets for printing outstanding image portion 314 is not sufficient for preventing clogging of those nozzles. Upon determination module 306 determining that ejection of imaging droplets for printing the outstanding image portion is sufficient for preventing clogging, the current image portion may be printed by ejecting only imaging droplets of the print fluid via nozzles of printhead 202.

For implementing its functionality, droplet ejection module 312 may access and modify servicing routines 316 stored in a data store 318 for accordingly implementing purging of print fluids. When executed, servicing routines 316 may be used to generate control data 105 illustrated above with respect to FIG. 1.

### Operations

FIGS. 4, 5 and 7 show flow charts for implementing at least some of the examples disclosed herein. In discussing FIGS. 4, 5 and 7, reference is made to FIGS. 1 to 3 to provide contextual examples. Implementation, however, is not limited to those examples. Reference is also made to the example forms depicted in FIG. 6. Again, such references are made simply to provide contextual examples.

FIG. 4 shows a flow chart 400 that implements examples of printer operation. Blocks in flow chart 400 may be executed by controller 148, shown in FIG. 1 or, more specifically, by the physical and logical components illustrated above with respect to FIG. 3.

At block 402, it is determined whether ejection of imaging droplets of a print fluid via a set of nozzles for printing an outstanding image portion (e.g., image portion 314 including one or more print swaths illustrated above regarding FIG. 3), is sufficient for preventing clogging of the set of nozzles. In some of these examples, the determination at block 404 includes determining whether the amount of imaging droplets for printing the outstanding image portion is above a selected droplet amount. If the amount of imaging droplets for printing the outstanding image portion is above the selected droplet amount, then it is determined that the droplets to be ejected are sufficient for preventing clogging of the nozzles.

The selected droplet amount may be selected by taking into account the amount of imaging droplets of the print fluid to be ejected for printing an outstanding image portion. More specifically, a particular type of nozzles may require that a certain number of droplets N are ejected within a certain time T for preventing nozzle clogging. It might be then determined whether the number of droplets Nᵢ to be ejected during printing of the outstanding image portion makes that the total number of droplets being ejected in an outstanding time period Tᵢ is above N. The outstanding time period may be selected dynamically during printing depending on the print parameters (e.g., ink type).

In some examples, the selected droplet number is selected taking also into account the amount of imaging droplets of the print fluid ejected for printing a precedent image portion. For example, it might be determined whether the number of droplets Nᵢ to be ejected during printing of an outstanding image portion (e.g. an outstanding print swath) plus the number of droplets Nᵢ₋₁ ejected during printing of a precedent image portion (e.g. a precedent print swath) makes the total number of droplets being ejected in a time period Tᵢ greater than N.

The selected droplet number referred to above may be a predetermined fixed droplet number. For example, it might be pre-determined that ejecting a certain number of droplets per print swath renders servicing unnecessary. In other examples, the selected droplet number is selected dynamically by considering print conditions such as ambient temperature, humidity, or other parameters that might influence nozzle clogging. Some more specific examples for implementing block 402 are set forth below with respect to FIG. 7.

At block 404, different printing procedures are followed depending on the result of the determination at block 402.

Upon determining that ejection of imaging droplets for printing the outstanding image portion is sufficient for preventing clogging of the set of nozzles, flow chart 400 goes from block 404 to block 406, in which the outstanding image portion is printed by ejecting only imaging droplets of the print fluid via the set of nozzles. That is, in the moment that it is determined that for an outstanding image portion (e.g., one or more outstanding print swath) nozzle servicing is redundant, then, for printing a subsequent image portion, no flying spit is performed since ejection of purging droplets would result in an unnecessary waste of print fluid.

Upon determining that ejection of imaging droplets for printing an outstanding image portion is not sufficient for preventing clogging of the set of nozzles, flow chart 400 goes from block 404 to block 408, in which a servicing procedure is executed to eject purging droplets of the print fluid via the set of nozzles over a printing area and/or a service station.

Flow chart 400 may be repeated for a plurality of image portions so as to accomplish printing of a whole image. For example, an image area to be printed may be divided in print swaths, and flow chart 400 may be executed for each print swath. Thereby, it is facilitated an efficient servicing of print nozzles which is also computationally efficient. In particular, flow chart 400 may be implemented for each print swath without thereby introducing a too long time delay that might significantly affect print speed.

FIG. 5 shows a flow chart 500 that implements examples of printer operation. Blocks in flow chart 500 may be executed by controller 148, shown in FIG. 1 or, more specifically, by the physical and logical components illustrated above with respect to FIG. 3.

At block 502, printing is performed over a print swath (e.g., print swath 222 depicted in FIGS. 2 and 3) for reproducing a portion of an image. Printing generally includes ejection of ink and, in some examples, treatment fluids, for reproducing an image portion with a selected print quality.

In performing printing at block 502, it is assessed at block 504 whether ejection of a print fluid via a set of nozzles for printing an outstanding image portion is above a selected droplet number. The nozzle set may correspond to nozzles in a printhead for ejecting a specific print fluid, e.g., a specific ink color or treatment fluid. The outstanding image portion may correspond to the image portion corresponding to the subsequent print swath. Thereby, a relatively simple but effective determination of whether servicing is required may be implemented. In other examples, the outstanding image portion may correspond to one or more subsequent or precedent print swaths. Thereby, computational requirements may be higher but a more efficient usage of print fluids is thereby facilitated. Details on how the selected droplet number may be chosen are set forth above with respect to FIG. 4.

If at block 504 it is determined that ejection of imaging droplets of the print fluid via the set of nozzles for printing the outstanding image portion (e.g., the outstanding print swath) is above the selected droplet number, then, at block 506, the print swath is printed by ejecting only imaging droplets of the print fluid via the set of nozzles, analogously as set forth above with respect to block 406 of FIG. 4.

If at block 504 it is determined that ejection of imaging droplets of the print fluid via the set of nozzles for printing an outstanding image portion (e.g., one or more outstanding print swaths) is above the selected droplet number, then, at block 502, the print swath is printed ejecting purging droplets of the print fluid via the set of nozzles. The purging droplets may be ejected over the print swath or over a dedicated servicing station. It will be understood that printing at block 508 also includes ejection of imaging droplets.

As set forth above, some of the examples disclosed herein may be implemented via a print density counting function. The print density counting function provides an estimate of the amount of print fluid to be printed in an outstanding image portion (e.g., an outstanding print swath) via a specific set of nozzles (e.g., the set of nozzles for ejecting ink of a specific color). The print density counting function may be used to determine whether imaging droplets of a print fluid to be ejected via a set of nozzles for printing of the image portion are sufficient for preventing clogging of the nozzle set. For example, it might be determined whether the value of the print density counting function for an outstanding print swath is above a selected threshold value. If the density value is beyond which nozzles does not require servicing for printing the outstanding print swath, then it is estimated that the nozzles do not require servicing. As set forth above, the print fluid density counting function may be provided via an application-specific integrated circuit module.

FIG. 6 illustrates an example of how a print density counting function 600 might be for determining whether servicing of nozzles is required for printing an outstanding image portion. In the illustrated example, print density counting function 600 may consist of the amount of print fluid to be ejected for an outstanding image portion 314 and per print fluid type. For example, function 600 may provide an ink amount to print a specific color in the next print swath. This amount might be made available from an ASIC module. The ASIC might provide a density function by counting the number of times that a hifipe level occurs in each density counting region 602a-602n. A hifipe level refers to the halftoning level for a specific pixel (the halftoning level is generally proportional to the number of drops to be ejected).

Each density counting region 602a-602n is defined by a region height 604 and a region width 606. The height 604 of the region in which the density function is to be evaluated might be selected as the height of the outstanding swath. The region width 606 may be programmable. For example, the region width 606 can be set to 64, 128, 256 or 512 pixels. A count value may be stored for each densitometer region 602a-602n so that an outstanding image portion for performing the servicing determination set forth above may be a portion of a print swath. Evaluation of density function 600 may be performed for both input and output planes. Thereby, values for density function 600 may be obtained both for a precedent image portion and a subsequent image portion.

FIG. 7 is a block diagram illustrating printer operation according to examples in which servicing determination is based on evaluation of density counting function 700.

At block 702 a print fluid amount is evaluated for a specific print fluid type to be ejected in an outstanding image portion 314 from a density function. For example, this print fluid amount might directly correspond to a density function value provided by ASIC 107 (see FIG. 1) and evaluated as illustrated above with respect to FIG. 6. In other examples, the print fluid amount might be derived from the density function to compute an amount parameter such as, but not limited to, drops per pixel (dpp).

From the evaluation at block 702, it might be determined at block 704 whether the nozzle sets are to be operated in an outstanding image portion. This determination might be straightforward: a non-zero value of the density function for an outstanding image portion is indicative of nozzle operation for printing that portion.

Upon determining that the nozzle set is to be operated, flow chart 700 might go from block 704 to block 706, in which it is determined whether the nozzle set requires servicing for printing an outstanding image portion. Otherwise, flow chart 700 might move to block 710 where the system is set to not perform spit since nozzle servicing would be redundant.

At block 706, the determination might be performed by comparing the print fluid amount 702 with a threshold value. Further examples of the determination at block 706 may be implemented analogously as in blocks 404 and 504 illustrated above with respect to, respectively, FIGS. 4 and 5. Upon determining at block 706 that servicing is required, print routines might be modified at block 708 for implementing flying spit as set forth above.

After any of blocks 708 or 710, flow chart 700 might go back to block 702. The shown cycle might be run for each time a print swath is to be printed and the outstanding image portions for which the spit assessment is performed might correspond to one or more subsequent print swaths.

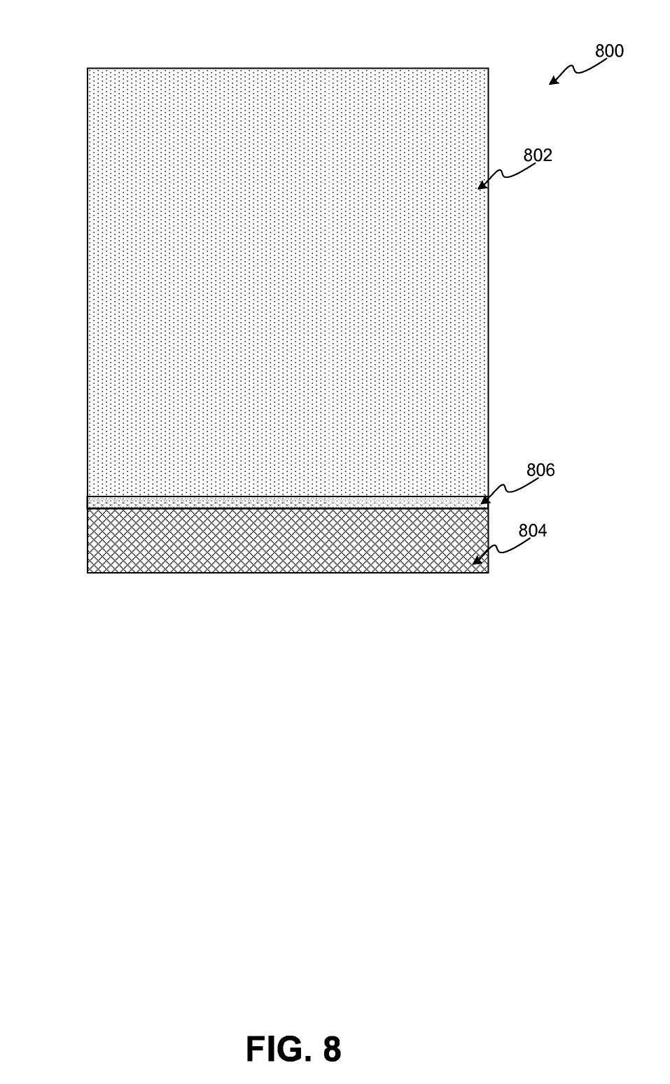

From the above, it is clear that at least some of the examples herein may affect how print fluids are ejected during printing. FIG. 8 illustrates an example in which servicing is implemented using flying spit. FIG. 8 shows an image 800 to be printed might be comprised of a relatively large image area (Area 802) filled with, for example, yellow color followed by a relative small area (Area 804) at the end filled with, for example black color. For printing Area 802, since yellow ink is the only print fluid to be fired, spitting for yellow ink is avoided by printing according to at least some of the examples here. Furthermore, spitting for any other color is not performed since, swath after swath, the techniques set forth above determine that other print fluids, e.g. black ink, are not to be ejected and therefore purging is unnecessary. According to examples herein, when the swath to be filled with black color is going to be printed, the set of nozzles for the black printhead can be previously prepared since it is determined that an outstanding print area (i.e., area 804 or a portion thereof) requires ejection of black ink and the corresponding nozzles require servicing for preventing nozzle clogging. In this example, black ink is spitted by flying spit over a print swath 806 previous to printing area 804. In other examples, the purging droplets might be gradually spitted on previous passes and/or be spitted on a service station.

It will be appreciated that examples above can be realized in the form of hardware, programming or a combination of hardware and the software engine. Any such software engine, which includes machine-readable instructions, may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of a tangible computer-readable storage medium that are suitable for storing a program or programs that, when executed, for example by a processor, implement embodiments. Accordingly, embodiments provide a program comprising code for implementing a system or method as claimed in any preceding claim and a tangible or intangible computer readable storage medium storing such a program. A tangible computer-readable storage medium is a tangible article of manufacture that stores data. (It is noted that a transient electric or electromagnetic signal does not fit within the former definition of a tangible computer-readable storage medium.)

In the foregoing description, numerous details are set forth to provide an understanding of the examples disclosed herein. However, it will be understood that the examples may be practiced without these details. While a limited number of examples have been disclosed, numerous modifications and variations therefrom are contemplated. It is intended that the appended claims cover such modifications and variations. Further, flow charts herein illustrate specific block orders; however, it will be understood that the order of execution may differ from that which is depicted. For example, the order of execution of two or more blocks may be scrambled relative to the order shown. Also, two or more blocks shown in succession may be executed concurrently or with partial concurrence. Further, claims reciting “a” or “an” with respect to a particular element contemplate incorporation of one or more such elements, neither requiring nor excluding two or more such elements. Further, at least the terms “include” and “comprise” are used as open-ended transitions.

What is claimed is:

1. A method of operating a printer for printing an image, the method comprising:
printing over a print swath for reproducing a portion of the image, wherein if ejection of imaging droplets of a print fluid via a set of nozzles for printing an outstanding image portion is above a selected droplet number, the print swath is printed by ejecting only imaging droplets of the print fluid via the set of nozzles, and
if ejection of imaging droplets of the print fluid for printing an outstanding image portion is below the selected droplet number, printing the print swath includes ejecting purging droplets of the print fluid via the set of nozzles.

2. The method of claim 1, wherein the outstanding image portion is an image portion corresponding to a subsequent print swath.

3. The method of claim 1, wherein the outstanding image portion is the image portion corresponding to one or more subsequent print swaths.

4. The method of claim 1, wherein the selected droplet number is selected taking into account the amount of imaging droplets of the print fluid to be ejected for printing the outstanding image portion.

5. The method of claim 4, wherein the selected droplet number is selected taking also into account the amount of imaging droplets of the print fluid ejected for printing a precedent image portion or an image portion being currently printed.

6. A computer software product comprising a tangible medium readable by a processor, the medium having stored thereon a set of instructions for operating a printer for printing an image, the instructions comprising:
(a) a set of instructions which, when loaded into a memory and executed by the processor, causes determining whether ejection of imaging droplets of a print fluid via a set of nozzles for printing an outstanding image portion is sufficient for preventing clogging of the set of nozzles;
(b) a set of instructions which, when loaded into a memory and executed by the processor, causes, upon determining that ejection of imaging droplets for printing the outstanding image portion is sufficient for preventing clogging of the set of nozzles, printing by ejecting only imaging droplets of the print fluid via the set of nozzles; and
(c) a set of instructions which, when loaded into a memory and executed by the processor, causes, upon determining that ejection of imaging droplets for printing the outstanding image portion is not sufficient for preventing clogging of the set of nozzles, execution of a servicing procedure to eject purging droplets of the print fluid via the set of nozzles.

7. The product of claim 6, wherein the outstanding image portion corresponds to one or more subsequent print swaths.

8. The product of claim 6, wherein determining whether ejection of imaging droplets for printing the outstanding image portion is sufficient for preventing clogging of the set of nozzles includes determining whether the amount of imaging droplets for printing the outstanding image portion is above a selected droplet amount.

9. The product of claim 6, wherein determining whether ejection of imaging droplets for printing the outstanding image portion is sufficient for preventing clogging of the set of nozzles includes determining whether the amount of imaging droplets for printing the outstanding image portion and an amount of imaging droplets for printing a precedent image portion is above a selected droplet amount.

10. The product of claim 6, wherein determining whether ejection of imaging droplets for printing the outstanding image portion is sufficient for preventing clogging of the set of nozzles includes determining whether the set of nozzles are to be operated for printing the outstanding image portion.

11. The product of claim 10, wherein determining whether ejection of imaging droplets for printing the outstanding image portion is sufficient for preventing clogging of the set of nozzles further includes, upon determining that the set of nozzles are to be operated for printing the outstanding image portion, determining whether the set of nozzles require servicing by ejection of purging droplets.

12. A printer for printing an image by ejection of print fluids, the printer comprising:
a controller to control printing of an image portion over a print swath by, for each print fluid:
determining for an outstanding print swath whether imaging droplets of a print fluid to be ejected via a set of nozzles for printing of the image portion are sufficient for preventing clogging of the nozzle set;
if it is determined that no imaging droplets of the print fluid are to be ejected for printing, ejecting purging droplets of the print fluid during printing if the set of nozzles requires servicing.

13. The printer of claim 12, wherein the controller includes an engine providing a print fluid density counting function providing an estimate of the amount of print fluid to be printed in the outstanding print swath via the set of nozzles, wherein the determining is performed based on, at least, the estimate of the amount of print fluid for printing the outstanding print swath.

14. The printer of claim 13, wherein the print fluid density counting function also provides an estimate of the amount of print fluid printed via the set of nozzles in one or more previous print swaths, wherein the determining is performed based on, at least, the estimate of the amount of print fluid to be printed and the amount of printed print fluid.

15. The printer of claim 13, wherein the engine includes an application-specific integrated circuit module customized for providing the print fluid density counting function.
